(19) United States
(12) Patent Application Publication
(10) Pub. No.: US 2006/0248728 A1
(43) Pub. Date: Nov. 9, 2006

(54) SAFETY LOCK FOR FOLDING KNIFE

(75) Inventor: Philip W. Gibbs, Camillus, NY (US)

Correspondence Address: BOND, SCHOENECK & KING, PLLC, ONE LINCOLN CENTER, SYRACUSE, NY, 13202-1355, US

(73) Assignee: CAMILLUS CUTLERY COMPANY, Camillus, NY (US)

(21) Appl. No.: 10/908,285

(22) Filed: May 5, 2005

(51) Int. Cl. B26B 1/02

(52) U.S. Cl. 30/161

(57) ABSTRACT

A safety lock for a folding knife comprising a sliding safety button positioned in a slot formed in one side of the knife handle. The button includes a first portion extending outwardly from the handle for manipulation by a user, and a second portion having a beveled surface that is slidingly engageable with a pin protruding from the blade tang. The pin in the blade tang may comprise a pre-existing structure, such as that included in some assisted opening mechanisms, or may be specifically added to the blade tang of a conventional folding knife for the purposes of forming the safety mechanism of the present invention.

### BACKGROUND OF THE INVENTION

The present invention relates to a safety feature for a folding knife and, more specifically, to a safety mechanism for insuring against inadvertent opening of the knife blade.

### DESCRIPTION OF PRIOR ART

Folding knives generally comprise a blade pivotally connected to a handle having a slot for receiving the blade in the closed a closed position. The blade may be opened by manually applying a force to the blade via a notch in the rear of the blade, a thumb stud on the side of the blade, or projecting portion extending from the blade tang. When the blade is stored within the handle it is generally safe for handling and transportation, such as in the pocket of its owner. However, the blade may come dislodged from the handle and move into an at least partially open position, thereby exposing the blade edge or blade point and presenting a hazard to the user.

Some folding knives include an assisted opening mechanism for biasing the blade into a closed position, and providing an opening force when the blade is manually opened a predetermined distance. For example, Applicant's co-pending U.S. application Ser. No. 10/680,751, hereby incorporated by reference, discloses a folding knife including a cantilever arm that acts on a cam pin to provide a closing force when the blade is moved into the handle toward the closed position, and an opening force when the blade is moved out of the handle toward the open position. Despite the closing force applied by the assisted opening mechanism, the blade may still be inadvertently opened to the point where the spring mechanism biases the blade into an open position, thereby presenting a danger.

Mechanisms for locking the blade in the closed position typically involve a spring arm or cantilever which extends along the rear of the handle cavity and engages the blade tang to lock the blade in the closed position. These mechanisms require the use of costly parts and rely on bias members which may lose resiliency over time, thereby reducing the effectiveness of the safety mechanism. These mechanisms also require manipulation of a strongly biased locking member, usually at a point on the handle that is not convenient for easy handling.

### OBJECTS AND ADVANTAGES

It is a principal object and advantage of the present invention to provide a lock for keeping a folding knife closed.

It is an additional object and advantage of the present invention to provide a lock for insuring that an assisted opening knife that does not inadvertently open.

It is a further object and advantage of the present invention to provide a lock that may be retrofit into pre-existing folding knifes requiring only minimal changes to the design and operation of the knife.

Other objects and advantages of the present invention will in part be obvious, and in part appear hereinafter.

### SUMMARY OF THE INVENTION

In accordance with the foregoing objects and advantages, the present invention comprises a safety lock that includes a button extending through a slot formed in one side of the knife handle, and that is manually slidable by a user to take the safety lock into and out of locked engagement relative to the blade. The button includes a first portion extending from the outside of the handle for manipulation by a user, and a second portion that is integral with and fixed to a body member that is moveable via the button between engaged and disengaged positions relative to a pin protruding from one side of the blade tang. The pin may comprise a pre-existing structure, such as that included in some assisted opening mechanisms, or may be specifically added to the blade tang of a conventional folding knife for the purposes of forming a part of the safety system of the present invention.

### BRIEF DESCRIPTION OF THE DRAWINGS

The present invention will be more fully understood and appreciated by reading the following Detailed Description in conjunction with the accompanying drawings, in which:

FIG. 1A is a side view of a folding knife including a safety mechanism according to the present invention, where the safety mechanism is in the “on” position.

FIG. 1B is a side view of a folding knife including a safety mechanism according to the present invention, where the safety mechanism is in the “off” position.

FIG. 2A is a side view of a conventional liner used in a spring assisted knife.

FIG. 2B is a side view of a conventional liner modified according to the present invention.

FIG. 3A is a side view of the outside surface of a handle modified according to the present invention.

FIG. 3B is a side cut-away view of the inside surface of a handle modified according to the present invention.

FIG. 4A is a top view of a safety lock according to the present invention.

FIG. 4B is a side view of a safety lock according to the present invention.

FIG. 4C is a bottom view of a button according to the present invention.

FIG. 5A is a side cut-away view of a folding knife including a safety mechanism according to the present invention.

FIG. 5A is a side cut-away view of a folding knife including a safety mechanism according to the present invention.

FIG. 6 is a side cut-away view of a folding knife including a safety mechanism according to the present invention.

FIG. 7A is side view of a folding knife including a safety mechanism according to the present invention.

FIG. 7B is a side cut-away view of the safety mechanism of the present invention in the “off” position.

FIG. 8A is a side view of the safety mechanism of the present invention in the “on” position.

FIG. 8B is a side cut-away view of the safety mechanism of the present invention in the “off” position.

FIG. 9 is an exploded perspective view of a folding knife including a safety mechanism according to the present invention.

### DETAILED DESCRIPTION

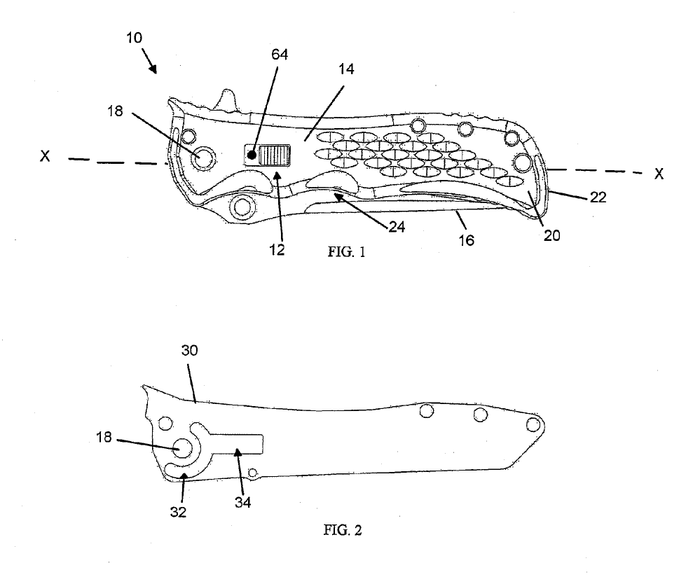

Referring now to the drawings, wherein like numerals refer to like parts throughout, there is seen in FIG. 1, a folding knife 10 including a safety lock 12 according to the present invention. Knife 10 generally comprises a handle 14 and a blade 16 mounted for pivotal movement about the longitudinal axis X-X of a pivot pin 18 with respect to handle 14. Handle 14 generally comprises opposing sides 20 and 22 extending along a longitudinal axis X-X and held in spaced relation relative to each other to form a blade receiving cavity 24. Handle 14 may further include decorative sculpting or designs on its outer surface.

Referring to FIG. 2, handle 14 further comprises a liner plate 30 positioned along the inside surface of handle piece 20. Liner plate 30 includes an arcuate opening 32 extending circumferentially about pivot pin 18 and in communication with a longitudinal opening 34 that extends along axis parallel to axis X-X away from pivot pin 18, as seen in FIG. 2B.

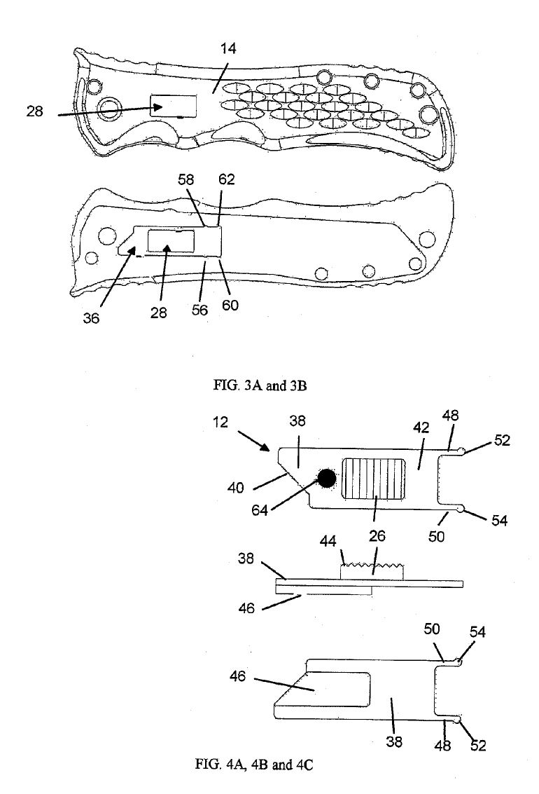

Referring to FIG. 3A, handle 14 includes a slot 28 for accepting safety lock 12 and allowing safety lock 12 to slide therein along an axis parallel to axis X-X, as described in further detain below. As seen in FIG. 3B, the inside surface of handle piece 20 includes a cavity 36 formed therein which is in communication with slot 28 and houses the remaining portions of safety lock 12 for sliding movement along an axis parallel to axis X-X.

Referring to FIGS. 4A, 4B and 4C, safety lock 12 includes a planar body 38 extending from a first end 40 of lock 12 to a second end 42 of lock 12 along an axis parallel to axis X-X. Safety lock 12 is adapted to be slidingly positioned in cavity 36 of handle 14. Safety lock 12 further includes a button 26 extending outwardly therefrom which is adapted to extend through and slide along slot 28 of handle 14. Button 26 includes an outer surface 44 adapted for engagement and manipulation by a user. Safety lock 12 further includes a reinforcing section 46 positioned on the opposing side of body 38 that is adapted to slidingly engage with longitudinal opening 34 of liner 30.

First end 40 of safety lock 12 is angled with respect to axis X-X so that the bevel faces outwardly from handle 14 in the direction from which blade 16 is received. Second end 42 of safety lock 12 includes two opposing bias arms 48 and 50 extending from body 38 for engagement with the inside of cavity 36. Safety lock 12 may be formed of any resilient material, such as plastic, and dimensioned such that bias arms 48 and 50 will frictionally engage the sides of cavity 36 and provide an outward biasing force. Bias arms 48 and 50 further include a pair of lobes 52 and 54 for releaseably engaging a first set of corresponding notches 56 and 58 formed along the inside of cavity 36 at a first predetermined position proximate to pivot post 18 and a second set of corresponding notches 60 and 62 formed along the inside of cavity 36 at a second predetermined position toward the opposing end of cavity 36.

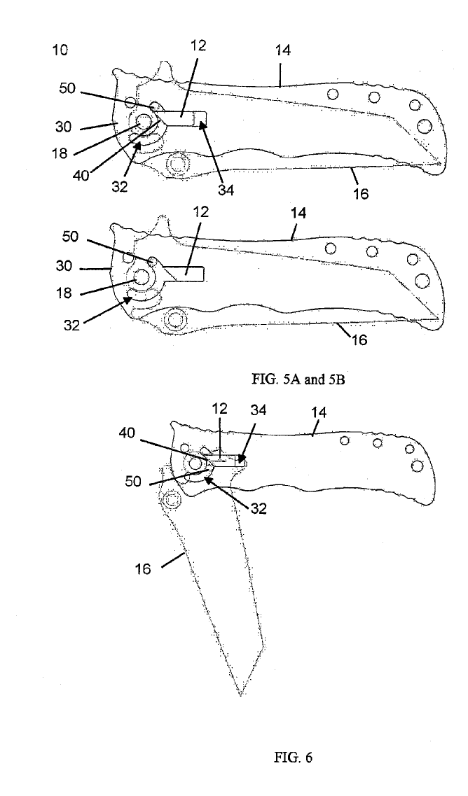

Referring to FIGS. 5A and 5B, safety lock 12 is slidingly positioned in cavity 36 so that the lateral edge of first end 40 engages a pin 50 attached to blade 16, thereby preventing the inadvertent opening of blade 16. Pin 50 is offset from pivot point of blade 14 and extends through the arcuate opening 32 of liner 30. As blade 14 is opened or closed, pin 50 travels along arcuate opening 32. In the case of a conventional folding knife, or a spring-assisted knife that does not use a cantilever arm and cam arrangement, pin 50 must be added to the side of blade 14. Pin 50 may comprise a pin that is press fit into the tang of blade 16, or otherwise integrated into the tang. Pin 50 may further comprise any form of protrusion extending outwardly from the tang of blade 16 which may be engaged by safety lock 12.

In the case of a spring-assisted knife that already includes an cam positioned in one side of the blade tang as part of the assisted opening mechanism, such as that described in U.S. application Ser. No. 10/680,751, the cam can be lengthened to extend through arcuate opening 32 in liner 30, thereby serving as pin 50. Alternatively, safety lock 12 and liner 30 may be positioned on the opposite side of handle 14 from the assisted opening mechanism spring mechanism, and the cam extended entirely through blade 14 to pass through arcuate opening 32 of liner 30.

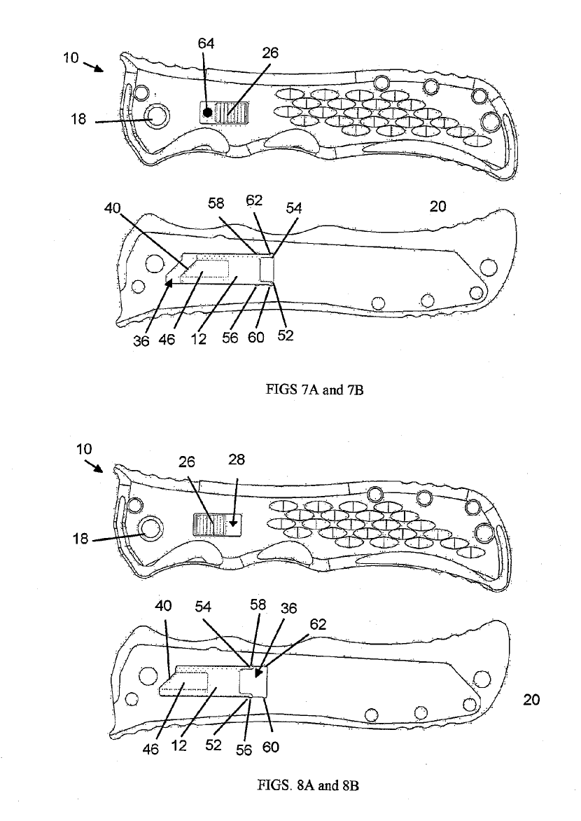

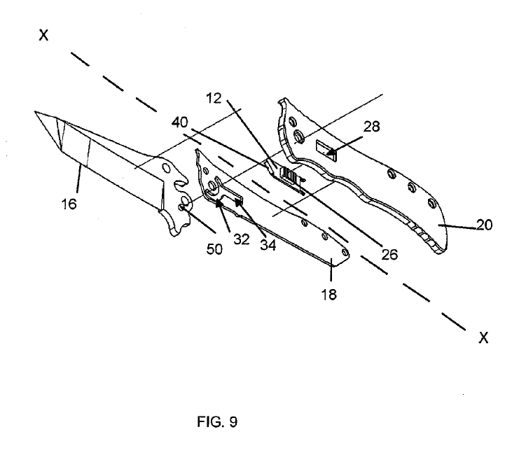

Referring to FIGS. 7A and 7B, safety lock 12 may be releaseably held in an “off” position by engagement of lobes 52 and 54 with notches 60 and 62 in cavity 36. Button 26 of safety lock 12 may further include a mark 64 on the outwardly facing surface of body 38 to visible indicate to a user whether safety lock 12 is “off” or “on” depending on the positioning of button 26 in slot 28. Referring to FIGS. 8A and 8B, notches 56 and 58 cooperate with lobes to 52 and 54 to releasably retain safety lock 12 in an “on” position.

Blade 16 may thus be locked in the closed position by sliding safety lock 12 toward pivot pin 18 until lobes 52 and 54 reach notches 56 and 58, respectively, and beveled front end 40 of safety lock 12 engages pin 50 residing at one end of arcuate slot 32. Blade 16 is unlocked or released by manipulating button 26 to that safety lock 12 slides rearwardly along slot 28 to disengage first end 40 of safety lock 12 from pin 50, thereby allowing pin 50 to travel along arcuate slot 32 of liner 30 so that blade 16 may pivot out of handle 14. Due to beveling of first end 40, blade 16 may be closed even if button 26 is inadvertently retained in the locked position, as pin 50 will engage beveled end 40 and force safety lock 12 rearwardly along longitudinal slot 34 into an unlocked position, as seen in FIG. 6.

What is claimed is:

1. A safety lock for a folding knife including a handle and a blade mounted for pivotal movement into and out of an opening in said handle, said lock comprising:
body having a first end and a second end, wherein said body is in sliding engagement with said handle;
slot formed in said handle;
button projecting outwardly from said body through said slot; and
pin attached to said blade, wherein said body is moveable with respect to said handle between a first position where said first end is engaged with said pin and a second position where said first end is disengaged from said pin.

2. The safety lock of claim 1, wherein said handle includes an outer surface, an inner surface, and a cavity formed in said inner surface.

3. The safety lock of claim 2, wherein said body is positioned in said cavity.

4. The safety lock of claim 3, wherein said second end of said body includes a pair of spring arms for engaging said inner surface of said handle.

5. The safety lock of claim 1, further comprising:
liner disposed along the inside of said handle;
n arcuate slot formed in said liner, wherein said pin travels along said slot as said blade moved between open and closed positions.

6. A folding knife comprising:
handle including first and second side pieces held in spaced relation to each other to define a blade receiving opening;
cavity formed in the inner surface of said first side piece;
a slot formed through said first side piece and in communication with said cavity a safety lock positioned in said cavity for movement along a longitudinal axis, wherein said safety lock includes a button projecting outwardly through said first side piece, a first end extending forwardly along said axis, a second end extending rearwardly along said longitudinal axis, and a reinforcing portion extending inwardly toward to blade receiving opening;
a liner including an arcuate slot and a longitudinal slot abutting first side piece and positioned so that said reinforcing portion extends through said longitudinal slot;
a blade pivotally mounted to said handle for movement into and out of said blade receiving opening;
a pin extending from a side of said blade and aligned for movement within said arcuate slot of said liner;
wherein said first end of said safety lock is moveable into engagement with said pin when said blade in the closed position.
